(19) United States
(12) Patent Application Publication
(10) Pub. No.: US 2009/0249070 A1
(43) Pub. Date: Oct. 1, 2009

(54) Method for Managing User Rights to Electronic Data Objects by a Person Who Acquires Rights

(75) Inventors: Jörg Abendroth, München (DE); Jorge Cuellar, Baierbrunn (DE); Michael Marhöfer, Deisenhofen (DE); Hariharan Rajasekaran, München (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/887,585

(22) PCT Filed: Mar. 30, 2006
(86) PCT No.: PCT/EP2006/061156

§ 371 Date: Oct. 1, 2007

(30) Foreign Application Priority Data
Apr. 1, 2005 (DE) 10 2005 015 113.2

(51) Int. Cl. H04L 9/32; G06F 21/00

(52) U.S. Cl. 713/170; 726/1

(57) ABSTRACT

Digital right management systems are technically constructed for protecting and carrying out wishes of a copyright holder such that the digital content is connected in a cryptographic and unique manner to any particular device and/or data carrier. Use of the digital content on other devices of the person who acquires rights is only possible after previous registration by the copyright holder. The person who acquires rights is enabled to manage the acquired rights thereof themselves on the electronic data object without instructing the intervention of a central copyright holder. This is accomplished by the person who acquires the rights creating partial amounts of the user rights having individual user rights. The digital content can be used, respectively, in the periphery of the created partial amounts of the individual user rights.

### CROSS REFERENCE TO RELATED APPLICATIONS

This application is based on and hereby claims priority to German Application No. 10 2005 015 113.2 filed on Apr. 1, 2005, the contents of which are hereby incorporated by reference.

### BACKGROUND

Described below are a method and a computer program product for managing user rights to electronic data objects by a person who acquires rights.

Unlike traditional information carriers (e.g. books and analog musical recordings), computer files and other digital media (CD, DVD) can be copied as required without a loss in quality and without appreciable costs.

Access to copy-protected electronic data objects such as for instance audio files, video files or software, is thus usually controlled by electronic protection measures known as Digital Rights Management (DRM) systems. They restrict access to digital offerings, e.g. to registered (i.e. paying) users, or even enable individual billing of individual accesses to an offering. In practice, this usually functions via specially developed file formats, which contain a copy protection system and/or an encryption. These files (i.e. music files from the internet) can then only be used with special programs and with a code associated therewith. Systems are also currently being tested, in which the home computer, prior to access to a digital content (display, print, reproduce) first queries a central computer as to whether the user has the necessary rights thereto. In this way, the central computer is then able to detect usage and debit the charges therefor directly from the account of the user's credit card.

DRM systems realize the idea of the central control of digital contents by cryptographic methods. This is realized by clearly cryptographically linking any digital content to any device and/or data carrier in a unique manner. Without obtaining the corresponding key for the digital content handed over from the copyright holder, the person who acquires rights is then able to acquire the device or data carrier, but is however not able to access the content. DRM systems are technically constructed for protecting and carrying out the wishes of a copyright holder, such that keys can be exchanged for each individual device without the control of the user. This provides copyright holders with new distribution schemes such as for instance a temporary leasing of the content.

To obtain access to the content of an electronic data object, the person who acquires rights requires the associated Rights Object, which controls access to the content of the electronic data object. Typical rights in such Rights Objects include the permission to reproduce, print, copy or edit the content of the electronic data object n times. These rights are in general recorded by the copyright holder in an individual Rights Object, which restricts the use of the electronic data object to one individual device of the person who acquires rights and rules out a change and/or modification to the rights by the person who acquires rights. In particular, restricting the use of the electronic data object to one individual device of the person who acquires rights is problematical if the person who acquires rights also wishes to use the electronic data object on other devices which are in his/her possession.

The Open Mobile Alliance Digital Rights Management Specification version 2 proposes, as a solution to this problem, that the person who acquires rights specify a number of devices which allow the copyright holder to use the electronic data object via a so-called Domain Rights Object. For the person who acquires rights, this network-centered solution means that he/she has to contact the copyright holder each time that he/she would like to add a device to his/her network or remove a device from his/her network.

The afore-mentioned scenario moves the copyright holder into a central role in terms of managing and carrying out rights, thereby resulting in the copyright holder being interested in restricting the number of devices by which an electronic data object using a predetermined license can be used. This represents a sensitive restriction in terms of the flexibility and freedom of a user in comparison with the current state of affairs, in which the person who acquires rights is able to use the electronic data object on as many devices as desired without needing to have this fact registered with any superior authority.

### SUMMARY

An aspect is thus to specify a user-centered method for managing user rights to electronic data objects by a person who acquires rights, which enables the person who acquires rights to manage his/her acquired rights to the electronic data object him/herself without herewith instructing the intervention of a central copyright holder. At the same time this should prevent the authorized interests of the copyright holder no longer being protected as a result of the greater flexibility for the person who acquires rights.

Accordingly, the user rights to the electronic data object can be divided into individual user rights for ways of utilization which can be defined by a copyright holder in a method for managing user rights to electronic data objects by the person who acquires rights. The person who acquires rights puts together subsets with individual user rights from the user rights. The electronic data object can be used in each instance within the scope of the combined subset of individual user rights. This is particularly advantageous in the case of high-value electronic data objects, since the original user rights can be stored in a safe location, whereas in the subset, less sensitive user rights for daily usage on a normal computer can be combined.

In accordance with an advantageous embodiment, a number of points is assigned to the individual user rights. The person who acquires rights acquires individual user rights with the aid of a points credit. A flexible tool is herewith advantageously given to the copyright holder in order to offer a number of services, like for instance subscriber services, bonus systems for loyal customers or the option of a particularly flexible pricing system. This possibility enables the person who acquires rights to customize his/her rights package according to his/her wishes in an uncomplicated fashion.

According to a further advantageous embodiment, provision is made for a cryptographic key for utilization of the electronic data object. The cryptographic key is transmitted when a user authorization is granted or a key for decrypting the cryptographic key is transmitted when a user authorization is granted.

Without restricting the generality of this term, the electronic data object includes software, text files, audio files, image files and video files. The predeterminable ways of utilization include reproducing, viewing, running, printing, copying and editing the electronic data object.

When running the computer program, the user rights to the electronic data object can be divided into individual user rights for ways of utilization which can be predetermined by a copyright holder in order to manage user rights to electronic data objects by a person who acquires user rights. Subsets with individual user rights can be combined from the user rights by the person who acquires user rights. The electronic data object can be used in each instance within the scope of the combined subset of individual user rights.

### BRIEF DESCRIPTION OF THE DRAWINGS

These and other aspects and advantages will become more apparent and more readily appreciated from the following description of an exemplary embodiment, taken in conjunction with the accompanying drawings of which:

FIG. 1 is a block diagram of a method for managing user rights to electronic data objects by a person who acquires user rights.

FIG. 2 is a table indicating assignment of points to individual user rights by a copyright holder.

FIG. 3 is a schematic representation for assigning points to individual user rights by a person who acquires user rights.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

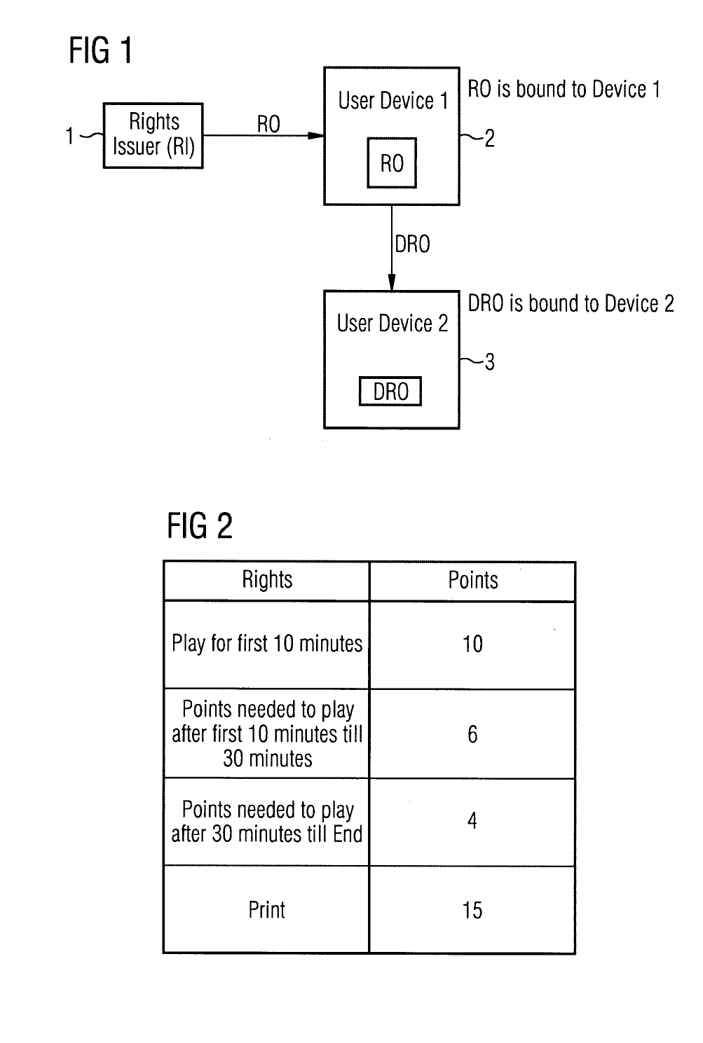

FIG. 1 shows a schematic representation of a method for managing user rights to electronic data objects by a person who acquires user rights. The copyright holder 1 issues a person who acquires rights with a license in the form of a Rights Object 2.

This Rights Object 2 includes all individual user rights which are included by the issued license for the respective data object. The person who acquires rights now forms a so-called Derived Rights Object (DRO) 3, in which he/she records individual user rights from the Rights Object 2. He/she is now able to store the electronic data object on a second device and to use the electronic data object within the scope of the user rights comprised by the Derived Rights Object 3.

According to a first exemplary embodiment, the person who acquires rights acquires very high-value software. The rights herewith acquired include the possibilities to copy, edit and run software n times. In typical cases, the person who acquires rights wishes only to run the software and does not require the rights for copying and editing the software. He/she subsequently creates a new Derived Rights Object which contains the rights for running the software n times. He stores the original Rights Object in a secure storage location. Together with the Derived Rights Object, he/she is now able to install the software on other devices in a problem-free manner and to use the software as provided for. A potential unauthorized user is now only able to run the software in accordance with the Derived Rights Object, whereas the more sensitive rights such as copying and editing are protected by the original Right Object at a safe location.

FIG. 2 shows a points table which specifies the number of points which are required for the use of an individual right of a specific electronic data object. A total of 10 points is thus required in this example for the reproduction of the first 10 minutes of an electronic data object, whereas the printing of the electronic data object already requires 15 points. These values apply to a device or to a network, depending on how the system is configured.

In accordance with a second exemplary embodiment, such a points table could be accessible for any individual wishing to use the content of the corresponding electronic data object. This points table lists all individual user right, which are assigned to the respective electronic data object and assigns to the individual user rights a number of points required by a person who acquires rights to use the rights. A person who acquires rights could now acquire any number of points and could distribute these points according to his/her wishes on individual user rights.

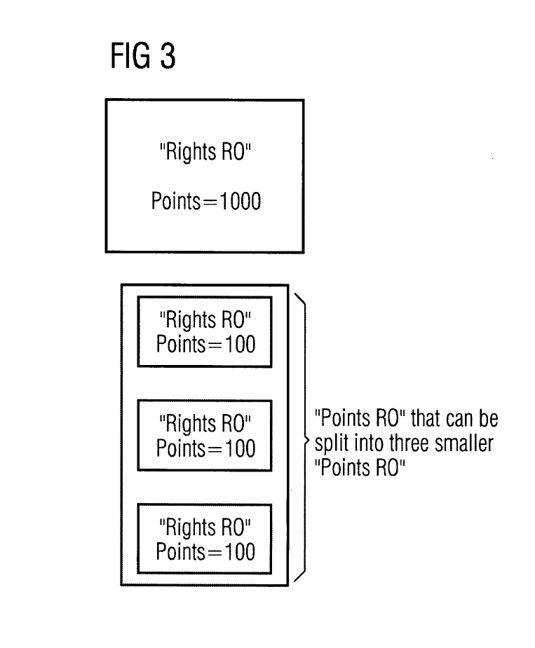

Such a procedure is shown in FIG. 3, in which a person who acquires rights has acquired a points credit of 1000 points. The person who acquires rights has withdrawn 100 points from this points credit on three occasions, in order to use them to acquire individual user rights. By way of example, he uses 100 points once in order to run the electronic data object on a device X and another 100 points in order to allow the electronic data object to run on device Y. Furthermore, he/she provides 100 points in order to allow the electronic data object to be printed on device X. He/she is able to book out the required points online and hereupon obtains the necessary keys from the copyright holder in order to release the electronic data object.

A cryptographic key for decrypting the content is provided for instance (Content Encryption Key) in order to utilize the electronic data object. This is transmitted by way of an encrypted message channel for instance. Alternatively, the cryptographic key is encrypted with a Public Key. The Private Key for decrypting the cryptographic key is then transmitted to the person who acquires rights by the copyright holder on receipt of the necessary points.

A description has been provided with particular reference to exemplary embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-6. (canceled)

7. A method for managing user rights to electronic data objects by a person who acquires rights, comprising:
dividing the user rights to an electronic data object into individual user rights for ways of utilization predetermined by a copyright holder,
combining the individual user rights into subsets by the person who acquires rights; and
using the electronic data object within a scope defined by one of the subsets of combined individual user rights.

8. The method as claimed in claim 7, further comprising:
assigning a number of points to the individual user rights; and
acquiring the individual user rights, by the person who acquires rights, based on a points credit.

9. The method as claimed in claim 8, further comprising:
providing a cryptographic key to enable said using of the electronic data object; and
transmitting at least one of the cryptographic key and a key for decrypting the cryptographic key, when a user authorization is granted.

10. The method as claimed in claim 9, wherein the electronic data object includes at least one of software, text, audio, image and video data.

11. The method as claimed in claim 10, with the ways of utilization including reproducing, running, printing, copying and editing the electronic data object.

12. At least one computer-readable medium encoded with a computer program which can be loaded into main memory of a program flow controller and includes at least one code section, during execution of which the program flow controller manages user rights to electronic data objects by a person who acquires rights by performing a method comprising:
dividing the user rights to an electronic data object into individual user rights for ways of utilization predetermined by a copyright holder,
combining the individual user rights into subsets by the person who acquires rights; and
using the electronic data object within a scope defined by one of the subsets of combined individual user rights.
